(19) United States
(12) Patent Application Publication
(10) Pub. No.: US 2007/0246876 A1
(43) Pub. Date: Oct. 25, 2007

(54) Reconfigurable Low-Profile Pneumatic Edge-Clamp Systems and Methods

(75) Inventors: Jeffrey H. Wood, Eureka, MO (US); Michael P. Matlack, St. Charles, MO (US); James A. Witte, O'Fallon, MO (US)

Correspondence Address: LEE & HAYES, PLLC, 421 W. RIVERSIDE AVE., SUITE 500, SPOKANE, WA, 99201, US

(73) Assignee: THE BOEING COMPANY, Chicago, IL (US)

(21) Appl. No.: 11/379,748

(22) Filed: Apr. 21, 2006

(51) Int. Cl. B23Q 3/08

(52) U.S. Cl. 269/22

(57) ABSTRACT

Pneumatic edge-clamp systems and methods are disclosed. In one embodiment, a clamping apparatus for applying a clamping force to a workpiece includes a beam member having a cavity disposed therein, and an inflatable member disposed within the cavity. The inflatable member is coupleable to a pressurization source. A clamping member is pivotably coupled to the beam member. The clamping member includes a first portion projecting at least partially over the cavity, and a second portion projecting laterally outwardly from the beam member over the workpiece. In operation, inflating the inflatable member applies a driving force to the first portion, rotating the clamping member, and applying a clamping force to the workpiece using the second portion.

### FIELD OF THE INVENTION

This invention relates to systems and methods for securing a workpiece during a manufacturing operation, and more specifically, to pneumatic edge-clamp systems and methods that may be used, for example, in welding or other manufacturing operations.

### BACKGROUND OF THE INVENTION

During many different types of manufacturing operations, it is necessary to secure the workpiece in position. For example, in the process of friction stir welding, a sheet aluminum panel is clamped against an aluminum substructure, such as an I-beam, to allow a high speed rotating spindle to engage the panel, causing friction-induced elevated temperatures which fuse the panel and substructure together.

One proven method of clamping the aluminum panel is to use commercially available pneumatic inflatable bladders which expand against the panel to restrain movement of the panel and press it firmly against the substructure. Such inflatable flexible bladders are typically contained in a low profile metal frame that is machined with an offset contour that matches the panel. The offset contour places the inflatable bladder slightly offset above the panel, allowing the flexible bladder to expand against and conform to the surface contour of the panel. A set of these metal frames can be placed nearby both sides of the friction stir welded joint to provide secure clamping on each side of the rotating spindle.

A problem may arise when the friction stir welded joint is located near the edge of the panel since there is no space on the outside edge of the joint for the typical metal frames which house the pneumatic inflatable bladders. Since it is desirable to have clamping force applied on both sides of the joint during the welding process, there is a need for an improved edge-clamping system that provides the desired clamping force on both sides of the joint during the welding process even near the edges of the panel.

### SUMMARY OF THE INVENTION

The present invention provides pneumatic edge-clamp systems and methods for securing a workpiece during a manufacturing operation. Embodiments of the present invention may advantageously provide a low-profile edge-clamping system that operates with a short displacement, conforms to the surface contour of the panel, provides quick actuation, and that is readily reconfigurable as needed.

In one embodiment, a clamping apparatus for applying a clamping force to a workpiece includes a beam member having a cavity disposed therein, and an inflatable member disposed within the cavity. The inflatable member is coupleable to a pressurization source. A clamping member is pivotably coupled to the beam member. The clamping member includes a first portion projecting at least partially over the cavity, and a second portion projecting laterally outwardly from the beam member over the workpiece. In operation, inflating the inflatable member applies a driving force to the first portion, rotating the clamping member, and applying a clamping force to the workpiece using the second portion.

### BRIEF DESCRIPTION OF THE DRAWINGS

Embodiments of the present invention are described in detail below with reference to the following drawings.

FIG. 1 illustrates a perspective view of components of a welding system formed in accordance with an embodiment of the present invention;

FIG. 2 illustrates a cross-sectional view of a portion of the welding system shown in FIG. 1;

FIG. 3 illustrates an exploded view of an edge-clamp frame and seal formed in accordance with an embodiment of the present invention;

FIG. 4 illustrates a perspective view of an edge-clamping component in accordance with an embodiment of the present invention;

FIG. 5 is an enlarged, partially exploded isometric view of a portion of the edge-clamping component of FIG. 4;

FIG. 6 is an enlarged, partially exploded isometric view of another portion of the edge-clamping component of FIG. 4; and

FIGS. 7 and 8 illustrate cross-sectional views of the clamping component of FIG. 4 in non-clamping and clamping modes, respectively.

### DETAILED DESCRIPTION

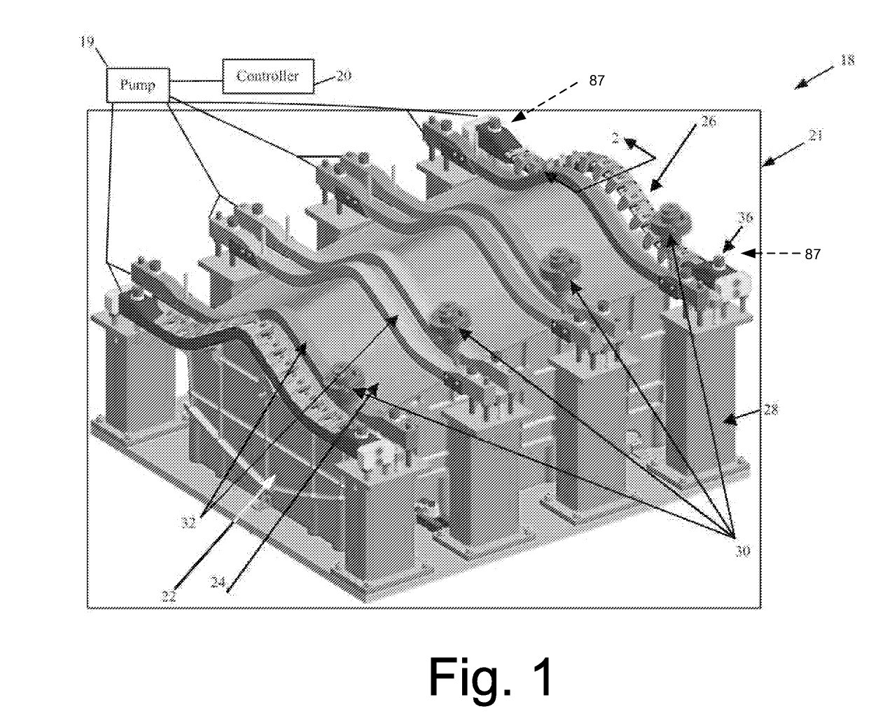

The present invention relates to pneumatic edge-clamp systems and methods for securing a workpiece during a manufacturing operation. Many specific details of certain embodiments of the invention are set forth in the following description and in FIGS. 1 through 8 to provide a thorough understanding of such embodiments. One skilled in the art, however, will understand that the present invention may have additional embodiments, or that the present invention may be practiced without several of the details described in the following description.

FIG. 1 illustrates a manufacturing system 18 in accordance with an embodiment of the present invention. In this embodiment, the manufacturing system 18 includes a controller 20, a pneumatic pump 19, and a clamping device 21. The controller 20 controls operation of the pneumatic pump 19 for supplying pressurized air to various components of the clamping device 21. The controller 20 may also control other components of the manufacturing system 18, including one or more tools 30 that perform manufacturing operations on one or more workpieces secured by the clamping device 21. In one embodiment, the tools 30 are welding components, such as friction stir welding heads or the like.

In one embodiment, the clamping device 21 includes one or more edge-clamp systems 26 and one or more pneumatic surface clamps 32 for securely positioning a first workpiece 24 with respect to a second workpiece 22 during the performance of the manufacturing operation (e.g. welding). The pneumatic surface clamps 32 and the edge-clamps systems 26 are attached to one or more fixture bases 28. As described more fully below, in one embodiment, the tools 30 may perform welding (e.g. friction stir welding) along pre-defined paths to securely bond the first and second workpieces 24, 22 together. In alternate embodiments, any other desired manufacturing operations may be performed.

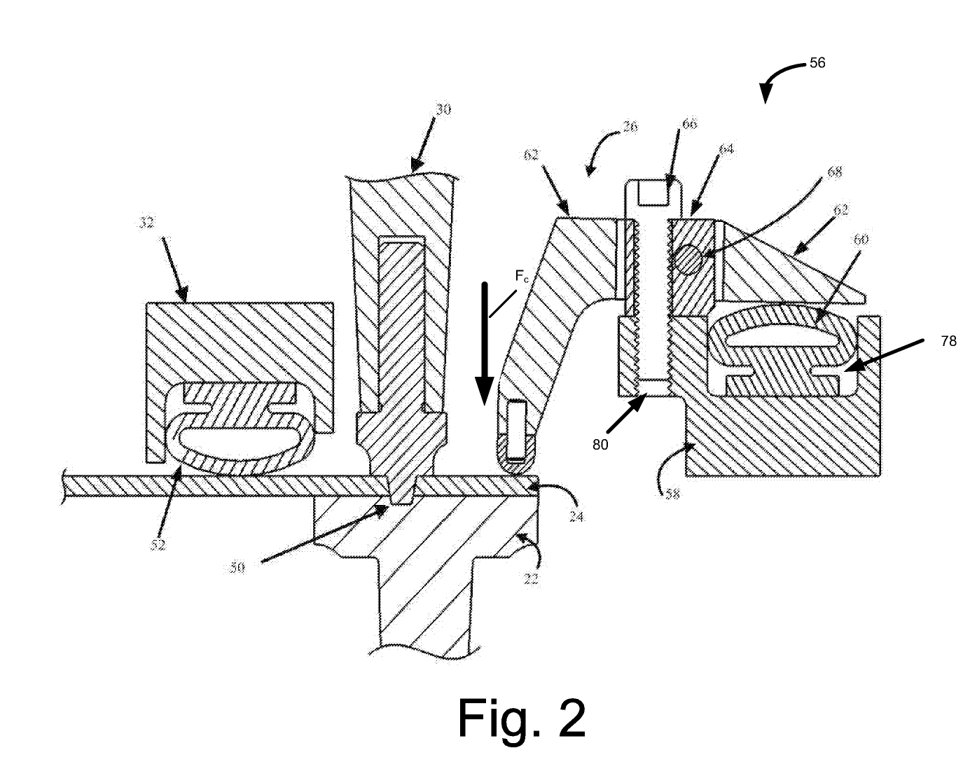

FIG. 2 illustrates a cross-sectional view of a portion of the manufacturing system 18 of FIG. 1. As shown in FIG. 2, in this embodiment, the pneumatic surface clamp 32 includes an inflatable seal 52 that, when inflated by the pump 19, applies pressure on the first workpiece 24, securely engaging the first workpiece 24 against the second workpiece 22. In one embodiment, the first workpiece 24 is a molded aluminum skin, such as that of a fuselage of an aircraft, and the second workpiece 22 is an aluminum stringer or beam suitable for use within an airframe. The structure and operation of the surface clamp 52 is described more fully, for example, in co-pending, commonly owned U.S. patent application Ser. No. 11/112,994 entitled “Inflatable Clamping Systems and Methods” filed on Apr. 22, 2005, incorporated herein by reference. Various alternate embodiments of clamping apparatus that may be substituted for the surface clamp 52 are described, for example, in co-pending, commonly owned U.S. patent application Ser. No. 10/648,535 entitled “Adaptable Spring Force Clamping Apparatus and Methods” filed on Aug. 25, 2003, incorporated herein by reference.

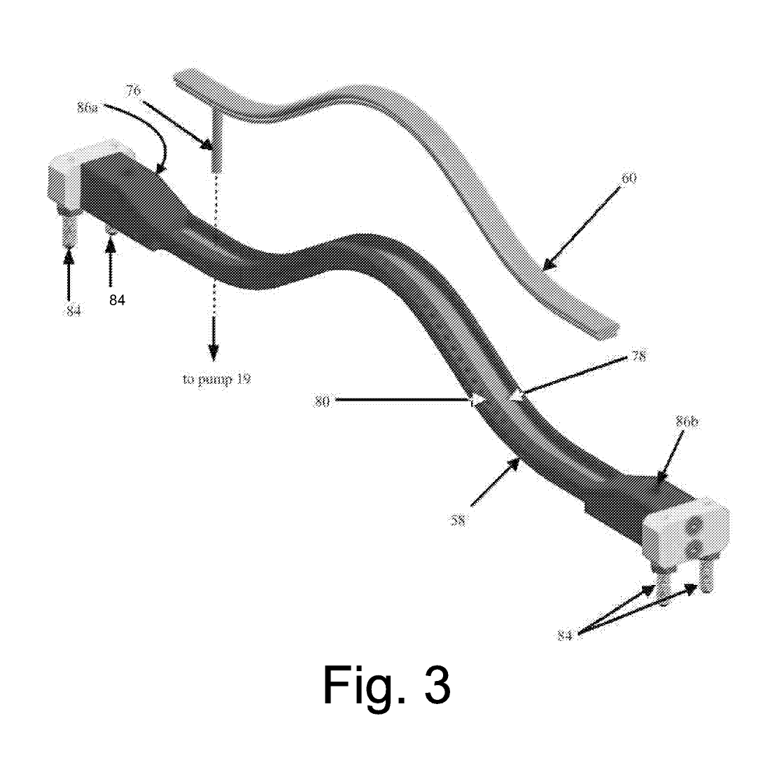

With continued reference to FIG. 2, in this embodiment, the edge-clamp system 26 includes an edge-clamp device 56 operatively coupled to a beam 58. The edge-clamp-device 56 includes a clamp bar 62 rotatably attached to a retainer block 64 by a pivot pin 68. A securing bolt 66 attaches the retainer block 64 to the beam 58. In this embodiment, the beam 58 includes an approximately U-shaped cavity 78 for receiving an inflatable bladder (or seal) 60, and a plurality of threaded holes 80 (FIG. 3) for receiving the securing bolt 66.

In operation, as the inflatable seal 60 is pressurized, the inflatable seal 60 applies pressure on a first portion of the clamp bar 62, rotating the clamp bar 62 about the pivot pin 68 and forcing a second portion of the clamp bar 62 downwardly to apply a clamping force F_{c} on the first workpiece 24. The edge-clamp system 26 thereby securely engages the first workpiece 24 against the second workpiece 22 during a manufacturing operation. In this embodiment, the tool 30 is placed between the edge-clamp system 26 and the surface clamp 34 in order to get the tool 30 as close as possible to a common edge of the first and second workpieces 22, 24.

Additional details of the edge-clamp system 26 are shown in FIG. 3. In this embodiment, the U-shaped cavity 78 extends from a first end 86a of the beam 58 to a second end 86b of the beam 58. The inflatable seal 60 is received within the cavity 78 and includes a stem 76 that passes through an opening in the cavity 78. The stem 76 is coupled to the pump 19. The inflatable seal 60 may be attached to the base of the cavity 78 using, for example, a suitable adhesive. In one particular embodiment, the inflatable seal 60 is a Presray Pneuma-seal® commercially-available from the Pawling Corporation of Pawling, N.Y.

In the embodiment shown in FIG. 1, each end 86a and 86b of the beam 58 includes through holes 87 for receiving the bolts 36 that secure the beam 58 onto the respective fixture bases 28. Alternately, each end 86a, 86b of the beam 58 includes a pair of threaded members 84 to secure the beam 58 to the bases 28 and to prevent movement of the beam 58 during a clamping process.

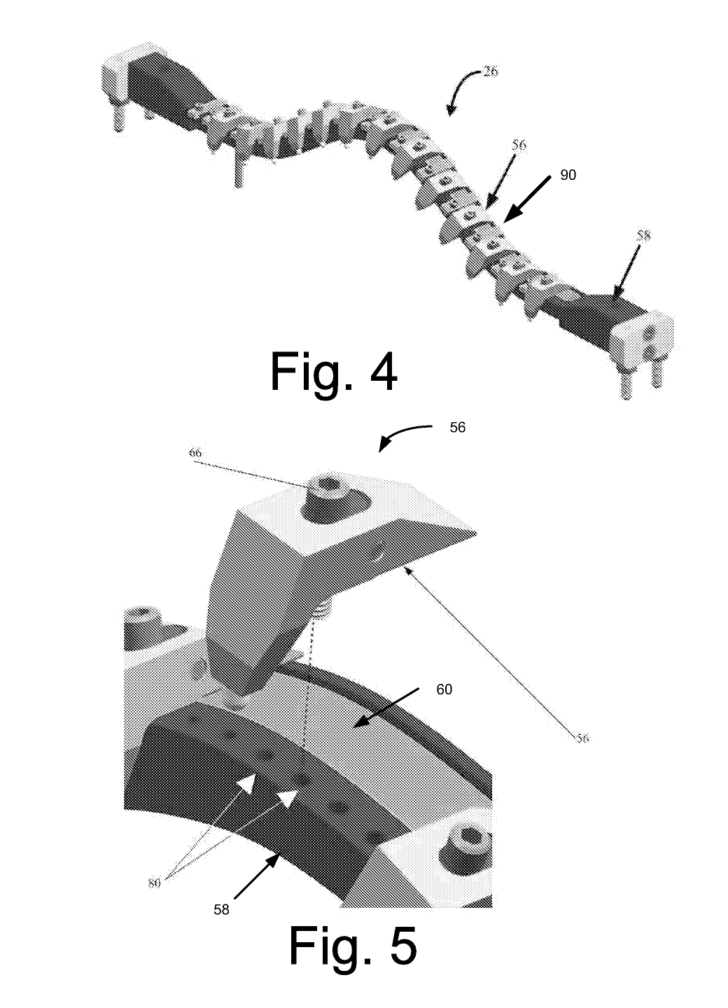

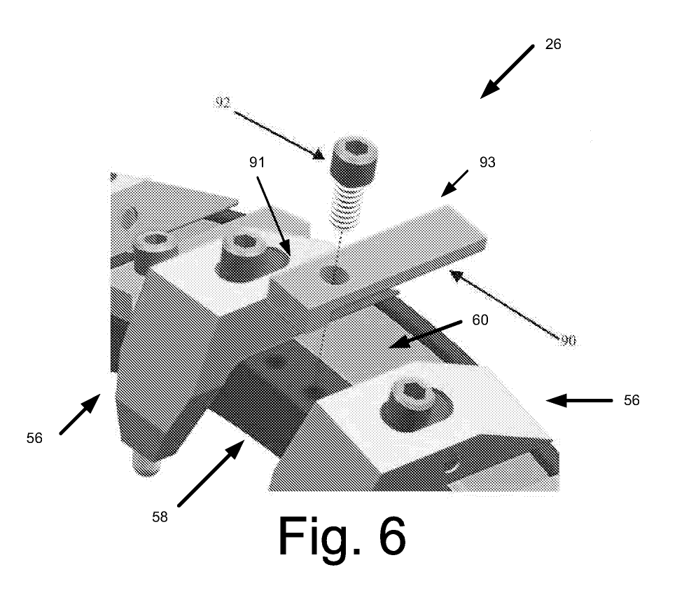

FIG. 4 illustrates a perspective view of the edge-clamp system 26 of FIG. 1. In this embodiment, a plurality of edge-clamp devices 56 are coupled to the beam 58, and a plurality of seal restriction members 90 are coupled to the beam 58 and interspersed between the edge-clamp devices 56. More specifically, as shown in the partially exploded view of FIG. 5, the securing bolt 66 is threaded through the retainer block 64 and received by one of the threaded holes 80 in the beam 58. In one embodiment, the edge-clamp devices 56 (and seal restriction members 90) are evenly distributed along the beam 58, however, in alternate embodiments, the edge-clamp devices 56 (and seal restriction members 90) may be non-uniformly distributed along the beam at desired locations depending upon the requirements of the manufacturing operation. In further embodiments, a greater or lesser number of edge-clamp devices 56 (and seal restriction members 90) may be employed than are shown in FIG. 4.

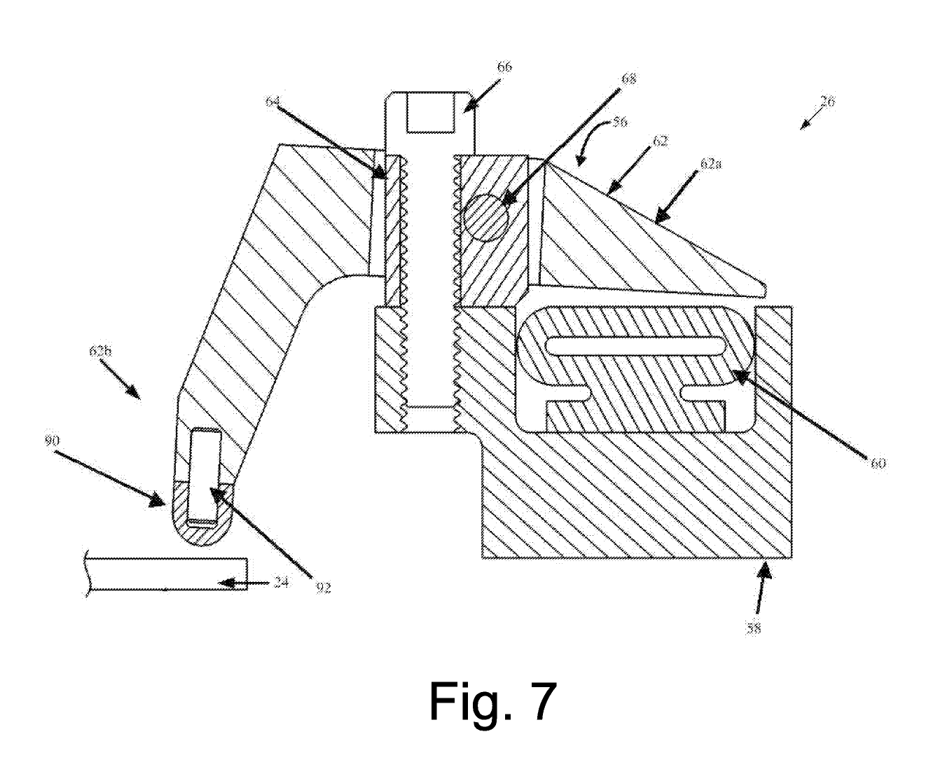

FIG. 6 is an enlarged partially-exploded view of a portion of the edge-clamp device 26 of FIG. 4. In this embodiment, the seal restriction member 90 is coupled to the beam 58 by a bolt 92 that passes through a hole in the seal restriction member 90 and is received by one of the threaded holes 80. In alternate embodiments, the seal restriction members 90 may be coupled to the beam 58 using any suitable attachment device, or alternately, may be integrally-formed with the beam 58. The seal restriction member 90, when attached to the beam 58, is configured to extend at least partially over the U-shaped cavity 78 of the beam 58, thereby restricting expansion of the inflatable seal 60 between the edge-clamp devices 56.

As shown in FIG. 6, in one embodiment, the seal restriction member 90 includes a first portion 91 that contacts the beam 58, and a second portion 93 that extends over the inflatable seal 60 disposed within the U-shaped cavity 78. The first portion 91 may have a greater thickness than the second portion 93. In this embodiment, the thicknesses of the first and second portions 91, 93 may be selected to allow the inflatable seal 60 to expand a pre-defined amount that would in turn allow the clamp bar 62 of the edge-clamp device 56 to rotate a pre-set amount, thereby putting proper pressure on the first workpiece 24.

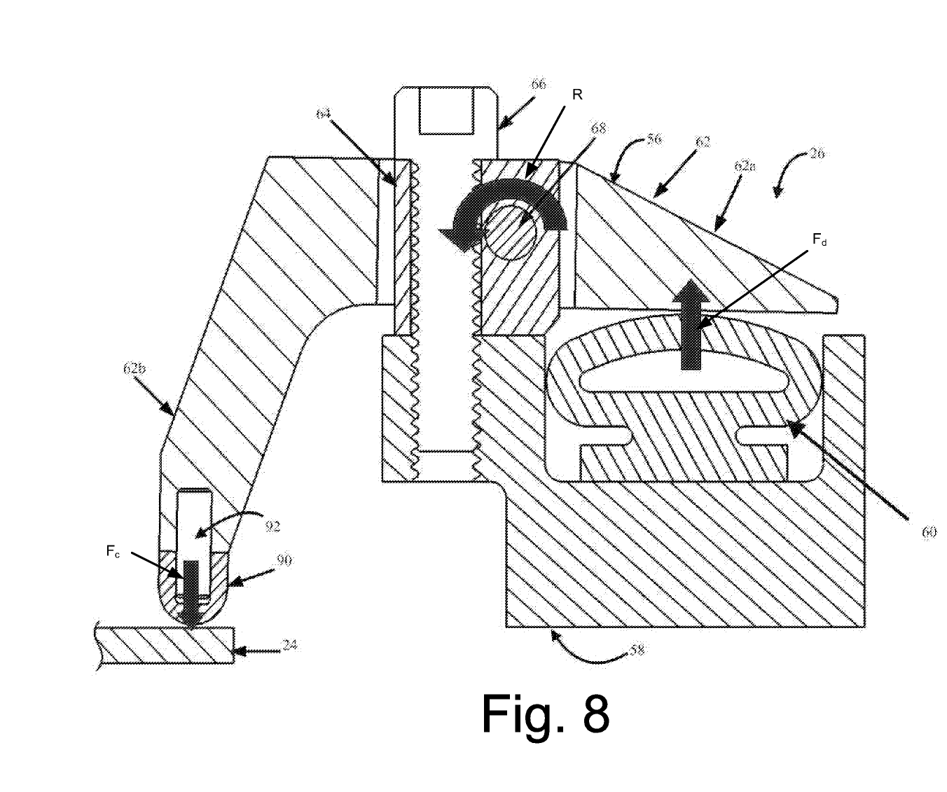

FIG. 7 shows an enlarged cross-sectional view of a portion of the edge clamp system 26 of FIG. 4. In this embodiment, the clamp bar 62 includes a non-abrasive tip 90 that engages the first workpiece 24 during the clamping operation. In one embodiment, the non-abrasive tip 90 is a polymer tip that reduces marring or scratching of the first workpiece 24 and reduces thermal conduction from the first workpiece 24 into the clamp bar 62 during manufacturing operations (e.g. welding). In this embodiment, the tip 90 is attached to the clamp bar 62 by an attachment pin 92. Alternately, the tip 90 may be adhesively attached, or attached by any other suitable means to the clamp bar 62.

FIG. 8 illustrates the rotational movement of the clamp bar 62 about the pivot pin 68 as the inflatable seal 60 is being pressurized. More specifically, as the inflatable seal 60 is pressurized, a driving force Fd is applied by the inflatable seal 60 against the first end 62a of the clamp bar 62, thus forcing the clamp bar 62 to rotate (generally depicted as arrow R) about the pivot pin 68. In turn, the second end 62b of the clamp bar 62 is forced downwardly, causing the tip 90 to apply the clamping force Fc onto the first workpiece 24. The clamping force Fc is maintained on the first workpiece 24 until the seal 60 is deflated.

Embodiments of the present invention may provide significant advantages over the prior art. For example, as depicted in FIG. 2, embodiments of edge-clamp systems 26 may allow an edge of a workpiece to be secured using less surface area of the workpiece than alternate clamping systems (e.g. pneumatic surface clamp 32), thereby allowing room for the tool 30 while properly securing the workpiece during the performance of manufacturing operations near the edge. Also, embodiments of the invention may provide a low-profile edge-clamping system that operates with a short displacement, thereby performing the desired clamping function without interfering with the performance of the manufacturing operations. Furthermore, as shown in FIGS. 1 and 4, embodiments of the invention may advantageously be configured to conform to a variety of surface contours, and may be readily reconfigurable by adjustment of the locations of the edge-clamp devices 56, the retaining members 90, and the shape of the beam 58. Finally, embodiments of the invention may provide relatively quick actuation in comparison with alternative clamping systems.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A clamping apparatus for applying a clamping force to a workpiece, comprising:
a beam member having at least one cavity disposed therein;
at least one inflatable member disposed within the at least one cavity and coupleable to a pressurization source; and
at least one clamping member pivotably coupled to the beam member, each clamping member including:
a first portion projecting at least partially over the cavity and engageable with the inflatable member, and
a second portion projecting laterally outwardly from the beam member and positionable over the workpiece, the at least one clamping member being configured such that as the inflatable member is inflated, a driving force is applied to the first portion and the clamping force is applied to the workpiece by the second portion.

2. The apparatus of claim 1, wherein the beam member comprises an elongated beam member having an elongated cavity disposed therein, and wherein the at least one inflatable member comprises an elongated inflatable member disposed within the elongated cavity.

3. The apparatus of claim 2, wherein the at least one clamping member comprises a plurality of clamping members distributed along the elongated beam member.

4. The apparatus of claim 3, wherein the elongated beam member comprises an at least partially contoured beam member.

5. The apparatus of claim 1, further comprising at least one retaining member coupled to the beam member and extending at least partially over the cavity.

6. The apparatus of claim 5, wherein the at least one retaining member includes a base portion engaged with the beam member and a retaining portion extending at least partially over the cavity, the base and retaining portions having differing thicknesses to at least partially control a magnitude of the driving force.

7. The apparatus of claim 1, wherein the beam member comprises an elongated beam member having an elongated cavity disposed therein, and the at least one inflatable member comprises an elongated inflatable member disposed within the elongated cavity, and wherein the at least one clamping member comprises a plurality of clamping members distributed along the elongated beam member, the apparatus further comprising a plurality of retaining members coupled to the elongated beam member and interspersed with the plurality of clamping members, each retaining member extending at least partially over the elongated cavity and engageable with the inflatable member when the inflatable member is inflated.

8. An assembly for performing a manufacturing operation on a workpiece, comprising:
a support structure configured to be positioned proximate the workpiece;
a clamping apparatus configured to apply a clamping force to the workpiece, the clamping apparatus including:
an elongated beam member coupled to the support structure and having at least one cavity disposed therein, the beam member being positionable proximate an edge portion of the workpiece;
at least one inflatable member disposed within the at least one cavity and coupleable to a pressurization source; and
at least one clamping member pivotably coupled to the beam member, each clamping member including:
a first portion projecting at least partially over the cavity and engageable with the inflatable member, and
a second portion projecting laterally outwardly from the beam member and positionable over the edge portion of the workpiece, the at least one clamping member being configured such that as the inflatable member is inflated, a driving force is applied to the first portion and the clamping force is applied to the workpiece by the second portion.

9. The assembly of claim 8, wherein the cavity comprises an elongated cavity, and the at least one inflatable member comprises an elongated inflatable member disposed within the elongated cavity, and wherein the at least one clamping member comprises a plurality of clamping members distributed along the elongated beam member.

10. The assembly of claim 9, further comprising a plurality of retaining members coupled to the elongated beam member and interspersed with the plurality of clamping members, each retaining member extending at least partially over the elongated cavity and engageable with the inflatable member when the inflatable member is inflated.

11. The assembly of claim 8, further comprising a pressurization source operatively coupled to the at least one inflatable member, and a controller operatively coupled to the pressurization source.

12. A method of performing a manufacturing operation on a workpiece, comprising:
positioning a beam member proximate the workpiece, the beam member having at least one cavity disposed therein;
pressurizing at least one inflatable member disposed within the at least one cavity;
applying a driving force against a first portion of a clamping member using the at least one inflatable member, the clamping member being pivotably coupled to the beam member;
pivoting the clamping member; and
applying a clamping force to the workpiece using a second portion of the clamping member, the second portion projecting laterally outwardly from the beam member over the workpiece.

13. The method of claim 12, wherein positioning a beam member proximate the workpiece includes positioning an elongated beam member proximate the workpiece, the elongated beam member having an elongated cavity disposed therein, and wherein pressurizing at least one inflatable member includes pressurizing an elongated inflatable member disposed within the elongated cavity.

14. The method of claim 13 wherein applying a driving force against a first portion of a clamping member includes applying a driving force against a plurality of first portions of a plurality of clamping members distributed along the elongated beam member, each clamping member being pivotably coupled to the beam member.

15. The method of claim 14, wherein positioning a beam member proximate the workpiece includes positioning an at least partially contoured beam member proximate the workpiece.

16. The method of claim 12, further comprising at least partially restricting an expansion of the inflatable member proximate the first portion of the clamping member using a retaining member coupled to the beam member and extending at least partially over the cavity.

17. The method of claim 16, wherein at least partially restricting an expansion of the inflatable member includes using a retaining member having a base portion engaged with the beam member and a retaining portion extending at least partially over the cavity, the base and retaining portions having differing thicknesses.

18. The method of claim 12, wherein:
positioning a beam member proximate the workpiece includes positioning an elongated beam member proximate the workpiece, the elongated beam member having an elongated cavity disposed therein;
pressurizing at least one inflatable member includes pressurizing an elongated inflatable member disposed within the elongated cavity;
applying a driving force against a first portion of a clamping member includes applying a driving force against a plurality of first portions of a plurality of clamping members, each clamping member being pivotably coupled to the beam member;
pivoting the clamping member includes pivoting the plurality of clamping members; and
applying a clamping force to the workpiece includes applying a plurality of clamping forces to the workpiece using a plurality of second portions of the plurality of clamping members, each second portion projecting laterally outwardly from the beam member over the workpiece.

19. The method of claim 18, further comprising at least partially restricting an expansion of the inflatable member proximate the plurality of first portions of the plurality of clamping members using a plurality of retaining members coupled to the beam member and extending at least partially over the cavity.

20. The method of claim 12, further comprising engaging a manufacturing tool with the workpiece.
